(19) United States
(12) Patent Application Publication
(10) Pub. No.: US 2020/0079895 A1
(43) Pub. Date: Mar. 12, 2020

(54) METHOD FOR PRODUCING TDI-BASED FLEXIBLE POLYURETHANE FOAMS CONTAINING ORGANIC ACID ANHYDRIDES AND/OR ORGANIC ACID CHLORIDES

(71) Applicant: COVESTRO DEUTSCHLAND AG, Leverkusen (DE)

(72) Inventor: Stefan LINDNER, Remscheid (DE)

(21) Appl. No.: 16/466,547

(22) PCT Filed: Dec. 4, 2017
(86) PCT No.: PCT/EP2017/081362

§ 371 Date: Jun. 4, 2019

(30) Foreign Application Priority Data
Dec. 5, 2016 (EP) 16202103.4

(51) Int. Cl. C08G 18/76; C08G 18/34; C08G 18/30; C08G 18/32; C08G 18/48

(52) U.S. Cl. CPC C08G 18/7621; C08G 18/341; C08G 2101/0008; C08G 18/3275; C08G 18/48; C08G 18/302

(57) ABSTRACT

The present invention relates to a method for producing TDI-based flexible polyurethane foams, particularly molded foams, using organic acid anhydrides and chlorides. The invention also relates to the flexible polyurethane foams produced by the method according to the invention.

### CROSS REFERENCE TO RELATED APPLICATIONS

This application is a national stage application under 35 U.S.C. § 371 of PCT/EP2017/081362, filed Dec. 4, 2017, which also claims priority to European application EP 16202103.4, filed Dec. 5, 2016, each of which is incorporated by reference herein.

### FIELD OF THE INVENTION

The present invention relates to a method for producing TDI-based flexible polyurethane foams, particularly molded foams, using organic acid anhydrides and/or organic acid chlorides. The invention also relates to the flexible polyurethane foams produced by the method according to the invention.

### DETAILED DESCRIPTION OF THE INVENTION

The production of polyurethanes by reacting polyisocyanates with polyols, catalysts which accelerate the reaction of polyols with isocyanates, and optionally blowing agents such as water, additives and/or auxiliaries, is generally known.

To produce cushioning elements, for example those which are used in the automobile industry, for example in the form of seat cushions, TDI-based flexible polyurethane foams play an essential role. In the production of such foams, a low isocyanate index can be advantageous, since a lower hardness can be achieved as a result. Moreover, these foams should have a high foam density since this leads to a better feeling of comfort. However, particularly in the production of such TDI-based flexible foams at low isocyanate index and having high foam densities, the problem arises to a great extent of elevated FOG values according to VDA 278. The VDA 278 test is a thermodesorption analysis of organic emissions for characterization of non-metallic motor vehicle materials. The sum total of the FOG value describes the proportion of condensable substances of a material, which can be determined with the aid of VDA 278. The target value of the FOG value is ≤250 mg/kg.

In the case of TDI-based molded flexible polyurethane foams, these relatively high FOG values particularly occur in the edge zone (skin) of the foam. It is desirable to reduce the content of these undesirable substances in the skin of the molded foams.

The object of the present invention was therefore the provision of TDI-based flexible polyurethane foams, preferably molded foams, which are produced at low isocyanate index and have a high foam density, and which at the same time have the lowest possible emissions in the VDA 278 (FOG value).

This object was achieved by means of two alternative routes:
by the concomitant use of a molar proportion of ≥0.20 to ≤1.25 mol % of at least one cyclic carboxylic anhydride, based on the amount of TDI used, in the polyurethane production, or
by the concomitant use of a molar proportion of ≥0.15 to ≤1.25 mol % of at least one carbonyl chloride, based on the amount of TDI used, in the polyurethane production.

The molar proportion is calculated as follows:

$$Molar fraction [ mol - \% ] = \frac{\frac{m ( acid anhydride )}{M ( acid anhydride )}}{\frac{m ( TDI )}{M ( TDI )}} * 100 \% \qquad ( I )$$

where m is the mass and M is the molar mass. In the case of polymeric compounds, i.e. compounds having two or more anhydride groups, the molar proportion [mol %] is calculated by producing the quotient of the mass m of the acid anhydride monomer and the molar mass of the acid anhydride monomer.

The calculation for the acid chloride is carried out analogously.

The invention therefore relates to a method for producing TDI-based flexible polyurethane foams, preferably molded foams, having a foam density of ≥20 kg m, by reacting TDI with at least one hydroxyl group-containing compound in the presence of blowing agents and optionally auxiliaries and/or additives, at an isocyanate index of ≥70 to ≤85, characterized in that the reaction is carried out
in the presence of ≥0.20 to ≤1.25 mol %, preferably ≥0.25 to ≤1.0 mol %, particularly preferably ≥0.26 to ≤1.0 mol % of at least one cyclic anhydride of a di- and/or polycarboxylic acid, based on the amount of TDI used, or
in the presence of ≥0.15 to ≤1.25 mol %, preferably ≥0.25 to ≤1.0 mol %, particularly preferably ≥0.26 to ≤1.0 mol % of at least one carbonyl chloride, based on the amount of TDI used.

In the context of the invention, cyclic anhydrides are understood to mean anhydrides which form intramolecularly by elimination of water from di- or polycarboxylic acids.

The invention further also relates to the flexible polyurethane foams obtainable by this method, wherein preference is given to molded foams.

EP 1 117 718 B describes a method for producing foamed polyisocyanate polyaddition products using organic or inorganic acid anhydrides for the purposes of reducing the amine content in the foams. However, TDI is also mentioned in a long list of isocyanates to be used. There is no reference specifically to TDI-based foams or even more specifically to TDI-based molded foams which are produced at an isocyanate index of a maximum of 85 and having a foam density of at least 20 kg m⁻³. Even fewer in the document are references to the fact that the problem of reducing amines in these specific foams and the emissions associated thereto can be solved by using anhydrides in amounts of 0.20 to 1.25 mol %, based on the amount of TDI used. On the contrary: the EP document generally refers to amounts of 0.1 to 6 percent by weight (page 7, [0052]). In the examples based on TDI, however, the anhydrides are used in amounts of at least 1.0 percent by weight (Table 6, Example 23 (maleic anhydride)), corresponding to about 1.776 mol %, to 4.3 percent by weight (Table 6, Example 26 (dodecenylsuccinic anhydride)), corresponding to about 2.811 mol %. Thus, EP 1 117 718 BI teaches far from the use of anhydrides in the range claimed in the present invention.

DE 10343099 describes the production of polyurethane moldings, in which carboxylic anhydrides are added to the isocyanate for the purpose of reducing the amine content. In this case, these are anhydrides of monocarboxylic acids (claim 1, and paragraph [0014], 12th line and paragraph [0016]) and polyanhydrides of mono- or polycarboxylic acids (claim 1 and paragraph [0014], 14th/15th lines). The use of cyclic anhydrides of di- or polycarboxylic acids is not described. The amounts of anhydride used are very high at 10% by weight, based on the isocyanate component (TDI-based examples in [0063] and [0064].)

### Description of the Method and Product Parameters and the Components to be Used in the Method According to the Invention:

As stated above, the invention relates to a method for producing TDI-based flexible polyurethane foams, preferably molded foams, having a foam density of ≥20 kg m³, by reacting TDI with at least one hydroxyl group-containing compound in the presence of blowing agents and optionally auxiliaries and/or additives, at an isocyanate index of ≥70 to ≤85, characterized in that the reaction is carried out
in the presence of ≥0.20 to ≤1.25 mol %, preferably ≥0.25 to ≤1.0 mol %, particularly preferably ≥0.26 to ≤1.0 mol % of at least one cyclic anhydride of a di- and/or polycarboxylic acid, based on the amount of TDI used, or
in the presence of ≥0.15 to ≤1.25 mol %, preferably ≥0.25 to ≤1.0 mol %, particularly preferably ≥0.26 to ≤1.0 mol % of at least one carbonyl chloride, based on the amount of TDI used.

If a mixture of two or more anhydrides is used, the amounts refer to the sum total of anhydrides. If a mixture of two or more chlorides is used, the amounts refer to the sum total of chlorides.

The isocyanate index (also index) indicates the percentage ratio of the amount of isocyanate actually used to the stoichiometric amount of isocyanate groups (NCO), i.e. that amount calculated for the conversion of the OH equivalents:

Index=(amount of isocyanate used):(isocyanate amount calculated)·100 (II)

The foam density of the foam is preferably ≥30 kg m³, particularly preferably ≥40 kg m³.

The cyclic anhydrides used are, for example, compounds of the formula (III), (IV) or (V)

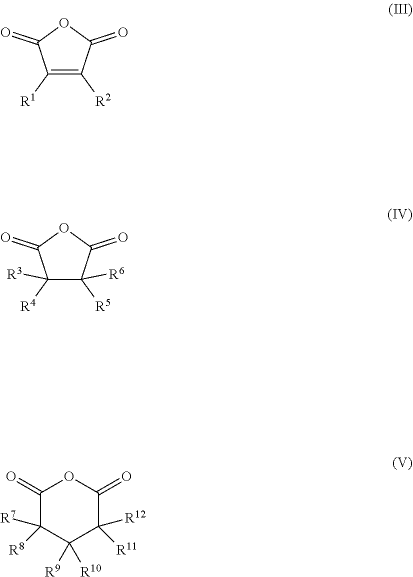

wherein
R1 and R2 are each hydrogen, halogen, C1-C22-alkyl, C1-C22-alkenyl or C6-C18-aryl, or R1 and R2 may each be members of a 4- to 7-membered ring or polycyclic system, R1 and R2 together preferably forming a benzene ring,
R3, R4, R5 and R6 are each hydrogen, C1-C22-alkyl, C1-C22-alkenyl or C6-C18-aryl or may each be members of a 4- to 7-membered ring or polycyclic system and
R7, R8, R9, R10, R11 and R12 are each hydrogen, C1-C22-alkyl, C1-C22-alkenyl or C6-C18-aryl or may each be members of a 4- to 7-membered ring or polycyclic system,
where the compounds of the formula III and IV and V may also be substituted by chlorine, bromine, nitro groups or alkoxy groups.

The cyclic anhydrides used are the following compounds for example: malonic anhydride, methylenemalonic anhydride, maleic anhydride, citraconic anhydride, 1,2-cyclohexanedicarboxylic anhydride, diphenic anhydride, phthalic anhydride, tetrahydrophthalic anhydride, methyltetrahydrophthalic anhydride, hexahydrophthalic anhydride, methylhexahydrophthalic anhydride, norbornenedioic anhydride and chlorination products thereof, nadic methyl anhydride (=methyl-5-norborneno-2,3-dicarboxylic anhydride), succinic anhydride, glutaric anhydride, diglycolic anhydride, naphthalene-1,8-dicarboxylic anhydride (naphthalic anhydride), naphthalene-1,2-dicarboxylic anhydride, succinic anhydride, 3- and 4-nitrophthalic anhydride, tetrachlorophthalic anhydride, tetrabromophthalic anhydride, itaconic anhydride, allylnorbornenedioic anhydride, adipic anhydride, bis(2,3-dicarboxyphenyl)methane anhydride, bis(3,4-dicarboxyphenyl)methane anhydride, 1,1-bis(2,3-dicarboxyphenyl)ethane anhydride, 1,1-bis(3,4-dicarboxyphenyl)ethane anhydride, 2,2-bis(2,3-dicarboxyphenyl)propane anhydride, 2,2-bis(3,4-dicarboxyphenyl)propane anhydride, bis(3,4-dicarboxyphenyl)sulfonic anhydride, bis(3,4-dicarboxyphenyl)ether anhydride, trimellitic anhydride (benzene-1,2,4-tricarboxylic anhydride), 4,4′-ethylene glycol bis-anhydrotrimellithate, 4,4′-(2-acetyl-1,3-glycerol) bis-anhydrotrimellithate, benzene-1,2,3-tricarboxylic anhydride (hemimellitic anhydride), mellophanic anhydride (benzene-1,2,3,4-tetracarboxylic anhydride), pyromellitic anhydride (benzene-1,2,4,5-tetracarboxylic anhydride), diphenyl-3,3′-4,4′-tetracarboxylic anhydride, diphenyl-2,2′-3,3′tetracarboxylic anhydride, naphthalene-2,3,6,7-tetracarbonxylic anhydride, naphthalene-1,2,4,5-tetracarboxylic anhydride, naphthalene-1,4,5,8-tetracarboxylic anhydride, decahydronaphthalene-1,4,5,8-tetracarboxylic anhydride, 4,8-dimethyl-1,2,3,5,6,7-hexahydronaphthalene-1,2,5,6-tetracarboxylic anhydride, 2,6-dichloronaphthalene-1,4,5,8-tetracarboxylic anhydride, 2,7-dichloronaphthalene-1,4,5,8-tetracarboxylic anhydride, 2,3,6,7-tetrachloronaphthalene-1,4,5,8-tetracarboxylic anhydride, phenanthrene-1,3,9,10-tetracarboxylic anhydride, perylene-3,4,9,10-tetracarboxylic anhydride, ethylenetetracarboxylic anhydride, butane-1,2,3,4-tetracarboxylic anhydride, cyclopentane-1,2,3,4-tetracarboxylic anhydride, pyrrolidine-2,3,4,5-tetracarboxylic anhydride, pyrazine-2,3,5,6-tetracarboxylic anhydride, thiophene-2,3,4,5-tetracarboxylic anhydride, benzophenone-3,3′,4,4′-tetracarboxylic anhydride, mellithic anhydride, alkyl- or alkenylsuccinic acids having unbranched or branched C1 to C24-alkyl or -alkenyl chains, such as (1-dodecen-1-yl) or 2-dodecen-1-yl)succinic anhydride, n-octenylsuccinic anhydride, tetradecenylsuccinic anhydride, hexadecenylsuccinic anhydride, octadecenylsuccinic anhydride, alkyl- and/or alkenylmaleic acids having unbranched or branched C1 to C24-alkyl or -alkenyl chains, such as dimethylmaleic anhydride, n-dodecenylmaleic anhydride, anhydrides based on adducts of maleic anhydride and styrene, anhydrides of maleic acid and any alkylenes, such as n-octylenesuccinic anhydride or n-dodecylenesuccinic anhydride, and/or copolymers of unsaturated carboxylic hydrides of the type mentioned above and any further comonomers such as isobutene and maleic anhydride, poly(ethylene-co-butyl acrylate-co-maleic dianhydride) and/or poly(styrene-co-maleic anhydride), wherein the corresponding diacids or polyacids are partially or preferably fully in the form of anhydrides. The comonomers, which can be co-polymerized with the unsaturated carboxylic acids or carboxylic anhydrides, that may be further used are, for example: olefins such as ethylene, propylene, n-butylene, isobutylene, n-octylene, n-dodicylene and diisobutene, vinyl alkyl ethers such as vinyl methyl ether, vinyl ethyl ether, vinyl propyl ether, vinyl isopropyl ether, vinyl butyl ether, vinyl isobutyl ether and vinyl tert-butyl ether, vinyl aromatics such as styrene and a-methylstyrene, furan and 2-methylfuran, diketene, acrylic and methacrylic acid deivatives, for example (meth)acrylamide, (meth)acrylonitrile, alkyl (meth)acrylates such as methyl (meth)acrylate, ethyl (meth)acrylate, propyl (meth)acrylate, butyl (meth)acrylate, isobutyl (meth)acrylate and tert-butyl (meth)acrylate, hydroxyalkyl (meth)acrylates such as hydroxyethyl (meth)acrylate, hydroxypropyl (meth)acrylate, hydroxybutyl (meth)acrylate and hydroxyisobutyl (meth)acrylate, vinylcarboxylic esters such as vinyl formate, vinyl acetate, vinyl butyrate and vinyl pivalate and other vinyl group-containing monomers such as N-vinylpyrrolidone, N-vinylcaprolactam, N-vinylformamide, N-vinylacetamide, N-vinylmethylacetamide and N-vinylimidazole.

Cyclic anhydrides preferably used are: maleic anhydride, succinic anhydride, citraconic anhydride, phthalic anhydride, naphthalic anhydride, pyromellitic anhydride, trimellitic anhydride, mellitic anhydride, nadic methyl anhydride (=methyl-5-norbomene-2,3-dicarboxylic anhydride), hexahydrophthalic anhydride, methylhexahydrophthalic anhydride, tetrahydrophthalic anhydride, methyltetrahydrophthalic anhydride, alkyl- and alkenylsuccinic acids having unbranched or branched C1 to C24 alkyl or alkenyl chains such as (1-dodecen-1-yl) or (2-dodecen-1-yl)succinic anhydride, alkyl and/or alkenylmaleic acids with unbranched or branched C1 to C24 alkyl or alkenyl chains such as n-dodecenylmaleic anhydride, adducts of maleic anhydride and styrene, anhydrides of maleic acid and any alkylenes, such as n-octylenesuccinic anhydride or n-dodecylenesuccinic anydride, copolymers of unsaturated carboxylic hydrides and alkenes, for example the comonomers described above.

Particularly preferred cyclic anhydrides are maleic anhydride, succinic anhydride, citraconic anhydride, phthalic anhydride, naphthalic anhydride, nadic methyl anhydride (=methyl-5-norbornene-2,3-dicarboxylic anhydride), hexahydrophthalic anhydride, methylhexahydrophthalic anhydride, tetrahydrophthalic anhydride, methyltetrahydrophthalic anhydride and alkyl- and alkenylsuccinic acids having unbranched or branched C1 to C24 alkyl or alkenyl chains such as (l-dodecen-1-yl) or (2-dodecen-1-yl)succinic anhydride, and alkyl- and/or alkenylmaleic acids having unbranched or branched C1 to C24 alkyl or alkenyl chains such as n-dodecenylmaleic anhydride.

The cyclic anhydrides can be used in a mixture with the polyol component and/or the TDI. Preferably, the anhydrides are added in a mixture with the polyol component briefly prior to the polyurethane reaction.

The carbonyl chlorides that can be used in accordance with the invention are not restricted. In general, aliphatic carbonyl chlorides having 2 to 22 carbon atoms or mixtures of C₈- to C₂₂-carbonyl chlorides, radicals of which can be branched or linear, saturated or unsaturated and optionally can be substituted, for example, by halogen or nitro groups, are used. Furthermore, it is possible to use aromatic and cycloaliphatic carbonyl chlorides and also aralkyl- or alkylaryl-substituted carbonyl chlorides having 7 to 24 carbon atoms. Suitable acid chlorides may comprise one to three carboxyl groups. Suitable aliphatic acid chlorides are, for example, pivaloyl chloride, 2-ethylhexanoyl chloride, stearoyl chloride, butyryl chloride, lauroyl chloride, palmitoyl chloride, acetyl chloride, neopentanoyl chloride, chloroacetyl chloride, dichloroacetyl chloride, adipoyl chloride, sebacoyl chloride, acryloyl chloride, methacryloyl chloride and so on. Suitable aromatic acid chlorides are, for example, benzoyl chloride, m-nitrobenzoyl chloride, isophthaloyl chloride, phenylacetyl chloride, p-chlorobenzoyl chloride, trans-cinnamoyl chloride, m-toluoyl chloride and so on. An example of a suitable cycloaliphatic acid is cyclohexanecarbonyl chloride.

In addition to polyether polyols, further hydroxyl group-containing compounds (polyols) can be used in the polyol formulation for producing polyurethanes. These polyols known per se are described in detail, for example, in Gum, Riese & Ulrich (Ed.): “Reaction Polymers”, Hanser Verlag, Munich 1992, pp. 66-96 and G. Oertel (Ed.): “Kunststoffhandbuch, Vol 7, Polyurethane”, Hanser Verlag, Munich 1993, pp. 57-75. Examples of suitable polyols are found in the literature references cited and also in U.S. Pat. No. 3,652,639, US-A4 421 872 and U.S. Pat. No. 4,310,632.

Preferred polyols used are polyether polyols (especially poly(oxyalkylene)polyols) and polyester polyols.

The production of the polyether polyols is carried out by known methods, preferably by base-catalyzed polyaddition of alkylene oxides onto polyfunctional starter compounds containing active hydrogen atoms, for example alcohols or amines. Examples include: ethylene glycol, diethylene glycol, 1,2-propylene glycol, 1,4-butanediol, hexamethylene glycol, bisphenol A, trimethylolpropane, glycerol, pentaerythritol, sorbitol, sucrose, degraded starch, water, methylamine, ethylamine, propylamine, butylamine, aniline, benzylamine, o- and p-toluidine, α,β-naphthylamine, ammonia, ethylenediamine, propylenediamine, 1,4-butylenediamine, 1,2-, 1,3-, 1,4-, 1,5- and/or 1,6-hexamethylenediamine, o-, m-, and p-phenylenediamine, 2,4-, 2,6-tolylenediamine, 2,2′-, 2,4- and 4,4′-diaminodiphenylmethane and diethylenediamine.

Preferably employed as alkylene oxides are ethylene oxide, propylene oxide, butylene oxide and mixtures thereof. The construction of the polyether chains by alkoxylation may be performed with only one monomeric epoxide or else in random or blockwise fashion with two or three different monomeric epoxides.

Processes for producing such polyether polyols are described in “Kunststoffhandbuch, volume 7, Polyurethane”, in “Reaction Polymers” and for example in U.S. Pat. Nos. 1,922,451, 2,674,619, US-A 1 922 459, U.S. Pat. Nos. 3,190,927 and 3,346,557.

The polyaddition may also be carried out with DMC catalysis for example. DMC catalysts and the use thereof for producing polyether polyols are described for example in U.S. Pat. Nos. 3,404,109, 3,829,505, 3,941,849, 5,158,922, 5,470,813, EP-A 700 949, EP-A 743 093, EP-A 761 708, WO-A 97/40086, WO-A 98/16310 and WO-A 00/47649.

In addition to these “simple” polyether polyols, the method according to the invention may also employ polyether carbonate polyols. Polyether carbonate polyols may be obtainable for example by catalytic reaction of ethylene oxide and propylene oxide, optionally further alkylene oxides and carbon dioxide in the presence of H-functional starter substances (see for example EP-A 2046861).

Methods for producing polyester polyols are likewise well known and described for example in the two abovementioned citations (“Kunststoffhandbuch, volume 7, Polyurethane”, “Reaction Polymers”). The polyester polyols are produced inter alia by polycondensation of polyfunctional carboxylic acids or derivatives thereof, for example acid chlorides or anhydrides, with polyfunctional hydroxyl compounds.

Employable polyfunctional carboxylic acids include for example: adipic acid, phthalic acid, isophthalic acid, terephthalic acid, oxalic acid, succinic acid, glutaric acid, azelaic acid, sebacic acid, fumaric acid or maleic acid.

Employable polyfunctional hydroxyl compounds include for example: Ethylene glycol, diethylene glycol, triethylene glycol, 1,2-propylene glycol, dipropylene glycol, 1,3-butanediol, 1,4-butanediol, 1,6-hexanediol, 1,12-dodecanediol, neopentyl glycol, trimethylolpropane, triethylolpropane or glycerol.

Production of the polyester polyols may moreover also be effected by ring-opening polymerization of lactones (for example caprolactone) with diols and/or triols as starters.

The polyether polyols, polyether carbonate polyols and polyester polyols described above can also be used concomitantly with filler-containing polyols such as polymer polyols (styrene-acrylonitrile copolymers) or polyurea dispersion polyols etc. for producing the flexible polyurethane foams.

In addition, in the production of the polyurethanes according to the invention, a crosslinker component can be added. Such crosslinkers that may be used are, e.g. diethanolamine, triethanolamine, glycerol, trimethylolpropane (TMP), adducts of such crosslinker compounds with ethylene oxide and/or propylene oxide having an OH number<1000 or also glycols having a number-average molecular weight≤1000. Particular preference is given to triethanolamine, glycerol, TMP or low EO- and/or PO adducts thereof.

In addition, known auxiliaries, additives and/or flame retardants can optionally be added. Auxiliaries are particularly understood here to mean catalysts and stabilizers known per se. As flame retardants, it is possible to use, e.g. melamine or TCPP.

Catalysts used are preferably aliphatic tertiary amines (for example trimethylamine, tetramethylbutanediamine, 3-dimethylaminopropylamine, N,N-bis(3-dimethylaminopropyl)-N-isopropanolamine), cycloaliphatic tertiary amines (for example 1,4-diaza[2.2.2]bicyclooctane), aliphatic amino ethers (for example bis(dimethylaminoethyl) ether, 2-(2-dimethylaminoethoxy)ethanol and N,N,N-trimethyl-N-hydroxyethylbisaminoethyl ether), cycloaliphatic amino ethers (for example N-ethylmorpholine), aliphatic amidines, cycloaliphatic amidines, urea, and derivatives of urea (for example aminoalkylureas; see, for example, EP-A 0 176 013, especially (3-dimethylaminopropylamino)urea). Incorporable or non-incorporable catalysts may also be used.

Catalysts used may also be tin(II) salts of carboxylic acids, where the respective parent carboxylic acid preferably has from 2 to 20 carbon atoms. Particular preference is given to the tin(II) salt of 2-ethylhexanoic acid (i.e. tin(II) 2-ethylhexanoate), the tin(II) salt of 2-butyloctanoic acid, the tin(II) salt of 2-hexyldecanoic acid, the tin(II) salt of neodecanoic acid, the tin(II) salt of oleic acid, the tin(II) salt of ricinoleic acid and tin(II) laurate. It is also possible to use tin (IV) compounds, for example dibutyltin oxide, dibutyltin dichloride, dibutyltin diacetate, dibutyltin dilaurate, dibutyltin maleate or dioctyltin diacetate as catalysts. It is of course also possible to use all the catalysts mentioned as mixtures.

Further representatives of the catalysts to be used and details of the mode of action of the catalysts are described in Vieweg and Höchtlen (Eds.): Kunststoff-Handbuch, Volume VII, Carl-Hanser Verlag, Munich 1966, pp. 96-102.

The catalysts are generally used in amounts of about 0.001% to 10% by weight, based on the total amount of compounds having at least two hydrogen atoms reactive toward isocyanates.

Further additives that may optionally be used are surface-active additives such as emulsifiers and foam stabilizers. Suitable emulsifiers are for example the sodium salts of castor oil sulfonates or salts of fatty acids with amines such as diethylamine oleate or diethanolamine stearate. Alkali metal or ammonium salts of sulfonic acids such as for instance of dodecylbenzenesulfonic acid or dinaphthylmethanedisulfonic acid or of fatty acids such as ricinoleic acid or of polymeric fatty acids can also be used as surface-active additives.

Foam stabilizers used are particularly polyethersiloxanes, especially water-soluble representatives. The construction of these compounds is generally such that a copolymer of ethylene oxide and propylene oxide is attached to a polydimethylsiloxane radical. Foam stabilizers of this type are described, for example, in U.S. Pat. Nos. 2,834,748, 2,917,480 and 3,629,308. Of particular interest are polysiloxane-polyoxyalkylene copolymers multiply branched via allophanate groups in accordance with DE-A 25 58 523.

Further potential additives are reaction retardants, for example acidic substances such as hydrochloric acid or organic acid halides, also cell regulators known per se such as paraffins or fatty alcohols or dimethylpolysiloxanes and pigments or dyes known per se and flame retardants, e.g. tris(2-chloroisopropyl) phosphate, tricresyl phosphate or ammonium phosphate and ammonium polyphosphate, also stabilizers for ageing and weathering effects, plasticizers and fungistatic and bacteriostatic substances as well as fillers such as barium sulfate, kieselguhr, carbon black or precipitated chalk.

Further examples of surface-active additives and foam stabilizers and cell regulators, reaction retarders, stabilizers, flame retardants, plasticizers, dyes and fillers and fungistatic and bacteriostatic substances for optional concomitant use according to the invention and details concerning use and mode of action of these additives are described in Vieweg and Höchtlen (Eds.): Kunststoff-Handbuch, Volume VII, Carl-Hanser Verlag, Munich 1966, pp. 103-113.

To be used as blowing agent component are all possible blowing agents known in polyurethane foam production. Organic blowing agents include, e.g. acetone, ethyl acetate, halogen-substituted alkanes such as methylene chloride, while inorganic blowing agents include e.g. air or CO₂. A blowing effect can also be achieved by addition of compounds which decompose with elimination of gases, for example of nitrogen, at temperatures above room temperature, for example azo compounds such as azodicarbonamide or azoisobutyronitrile. Particular preference is given to using water as chemical blowing agent. Further examples of blowing agents and details concerning use of blowing agents are described in Vieweg and Höchtlen (Eds.): Kunststoff-Handbuch, Volume VII, Carl-Hanser Verlag, Munich 1966, p. 108f, p. 453ff and p. 507ff. However, the sole blowing agent is preferably water or CO₂.

### Performance of the Method for Producing Polyurethane Foams

The production of isocyanate-based foams is known per se and described for example in DE-A 1 694 142, DE-A 1 694 215 and DE-A 1 720 768 and also in Kunststoff-Handbuch volume VII, Polyurethanes, edited by Vieweg and Höchtlein, Carl Hanser Verlag, Munich 1966, and in the new edition of this book, edited by G. Oertel, Carl Hanser Verlag Munich, Vienna 1993.

To carry out the method according to the invention, the reaction components are reacted by the one-step process known per se or by the prepolymer process or the semi-prepolymer process, often preferably using mechanical means, for example those described in U.S. Pat. No. 2,764,565.

The foams according to the invention are molded foams. The production of the foams is conducted in closed molds. In this case, the reaction mixture is introduced into a mold. Mold materials include metal, e.g. aluminum, steel or plastic, for example epoxide resin. In the mold, the foamable reaction mixture is foamed and forms the molded article. The mold foaming can be carried out in this case such that the molded article has cell structure on its surface. It can also be carried out such that the molded article has a compact skin and a cellular core. In accordance with the invention, it can be provided in this context that as much foamable reaction mixture is introduced into the mold that the foam formed just fills the mold. However, it can also be operated such that more foamable reaction mixture is introduced into the mold than is required to fill the mold interior with foam. In the latter-mentioned case, therefore, so-called overpacking is employed; a procedure of this type is known, for example, from U.S. Pat. Nos. 3,178,490 and 3,182,104.

During the mold foaming, “external release agents” known per se such as silicone oils are frequently used. However, so-called “internal release agents” can also be used, optionally in a mixture with external release agents, which are apparent, for example, from DE-OS 21 21 670 and DE-OS 23 07 589.

### EXAMPLES

The present invention is elucidated further by the examples which follow, but without being restricted thereto. These involve:

Hyperlite® Polyol 1629: product of Covestro. Reactive polyether polyol having an OH number of 31.5 mg KOH/g for producing cold-cure foams

Hyperlite® Polyol 1650: product of Covestro. Reactive polyether polyol having an OH number of 20.2 mg KOH/g, which has been modified with a SAN polymer (solids content: ca. 43% by weight).

B8736LF2: Tegostab® B8736LF2 is a silicone stabilizer for molded foam from Evonik

Dabco® 33LV: product of Air Products (mixture of 33% triethylenediamine and 67% dipropylene glycol)

Niax® A400: amine catalyst from Momentive

T80: Desmodur® T80 is a product from Bayer MaterialScience AG and consists of 2,4- and 2,6-diisocyanatotoluene.

Maleic anhydride: 99%, purchased from Sigma-Aldrich

Citraconic anhydride: purchased from Sigma-Aldrich

(2-Dodecen-1-yl)succinic anhydride: isomeric mixture for synthesis, purchased from Merck Millipore

Acid chloride additive: mixture of 50% by weight isophthaloyl dichloride which has been dissolved in 50 by weight Desmodur 1806 (product of Covestro)

Emission Measurement in Accordance with VDA278

The FOG value was determined in accordance with VDA 278, although the storage of up to 7 days was omitted. The samples were packaged in aluminum composite film 4 hours after production and stored in this manner until analysis. One piece from the edge zone of 1 mm thickness is investigated in the analysis. The analysis consists of a 2-stage process at 90° C. (for 30 minutes; VOC value) and 120° C. (for 60 minutes; FOG value). The substances emitted are transported in a helium stream and captured in a cold trap. The FOG value is the sum of all low-volatility compounds and is calculated as a hexadecane equivalent. Substances in the boiling range of n-alkanes from C14 to C32 are evaluated.

### Production of Flexible Molded Polyurethane Foams

The input materials recited in the examples of the table which follows are reacted with one another in the one-stage process in the manner of processing customary for the production of flexible moulded polyurethane foams in the cold-cure process. The reaction mixture is introduced into a metal mold that has been heated to 60° C. and coated previously with a release agent (PURA E1429H NV (Chem-Trend)). The usage amount is employed according to the desired foam density and mold volume. A 9.7 liter mold was used. The moldings were demolded and wrung-out after 4 minutes. After 4 hours the moldings were sealed in aluminum composite film.

| | OH | | | | | | | | | | Trial | Trial |
|---|---|---|---|---|---|---|---|---|---|---|---|---|
| Polyol | number | Comp. 1 | Comp. 2 | Trial 3 | Trial 4 | Comp. 5 | Comp. 6 | Trial 7 | Trial 8 | Comp. 9 | 10 | 11 |
| Hyperlite 1629 | 31.5 | 60 | 60 | 60 | 60 | 60 | 60 | 60 | 60 | 60 | 60 | 60 |
| Hyperlite 1650 | 20.2 | 40 | 40 | 40 | 40 | 40 | 40 | 40 | 40 | 40 | 40 | 40 |
| water (added) | 6228 | 2.738 | 2.738 | 2.738 | 2.738 | 2.738 | 2.738 | 2.738 | 2.738 | 2.738 | 2.738 | 2.738 |
| Diethanolamine | 1601 | 0.8 | 0.8 | 0.8 | 0.8 | 0.8 | 0.8 | 0.8 | 0.8 | 0.8 | 0.8 | 0.8 |
| B8736LF2 | 72 | 0.6 | 0.6 | 0.6 | 0.6 | 0.6 | 0.6 | 0.6 | 0.6 | 0.6 | 0.6 | 0.6 |
| | 0 | | | | | | | | | | | |
| Maleic anhydride | 0 | | | | 0.1 | 0.252 | 0.201 | | | | | |
| (dissolved in the | | | | | | | | | | | | |
| polyol) | | | | | | | | | | | | |
| Maleic anhydride | 0 | | 0.025 | 0.05 | | | | | | | | |
| (dissolved in | | | | | | | | | | | | |
| T80) | | | | | | | | | | | | |
| (2-Dodecen-1- | | | | | | | | 0.1 | 0.3 | | | |
| yl)succinic | | | | | | | | | | | | |
| anhydride (mixed | | | | | | | | | | | | |
| during | | | | | | | | | | | | |
| processing with | | | | | | | | | | | | |
| polyol) | | | | | | | | | | | | |
| Citraconic acid | 0 | | | | | | | | | | 0.1 | |
| (added to polyol | | | | | | | | | | | | |
| blend) | | | | | | | | | | | | |
| Acid chloride | | | | | | | | | | | | 0.1 |
| additive | | | | | | | | | | | | |
| Dabco 33LV | 552 | 0.3 | 0.3 | 0.3 | 0.3 | 0.3 | 0.3 | 0.3 | 0.3 | 0.3 | 0.3 | 0.3 |
| Niax A400 | 0 | 0.2 | 0.2 | 0.2 | 0.2 | 0.2 | 0.2 | 0.2 | 0.2 | 0.2 | 0.2 | 0.2 |
| Isocyanate | NCO % | | | | | | | | | | | |
| T80 | 48.3 | 25.14 | 25.14 | 25.14 | 25.14 | 25.14 | 25.14 | 25.14 | 25.14 | 35.2 | 25.14 | 25.14 |
| Index (100 | | 75 | 75 | 75 | 75 | 75 | 75 | 75 | 75 | 105 | 75 | 75 |
| NCO/OH) | | | | | | | | | | | | |
| Emisson result | | | | | | | | | | | | |
| (FOG value in | | | | | | | | | | | | |
| accordnace | | | | | | | | | | | | |
| with VDA278) | | | | | | | | | | | | |
| FOG value | | 256 | 278 | 165 | 101 | | | 223 | 142 | 144 | 168 | 159 |
| (hexadecane | | | | | | | | | | | | |
| equivalent) | | | | | | | | | | | | |
| [mg/kg] | | | | | | | | | | | | |
| Molecular | g/mol | | 98.06 | 98.06 | 98.06 | 98.06 | 98.06 | 266.38 | 266.38 | | 112.08 | 203.02 |
| weight | | | | | | | | | | | | |
| anhydride or | | | | | | | | | | | | |
| anhydride | | | | | | | | | | | | |
| wt % Anhydride | | 0 | 0.025 | 0.05 | 0.1 | 0.252 | 0.201 | 0.1 | 0.3 | 0 | 0.1 | 0.05 |
| or acid | | | | | | | | | | | | |
| chloride/100 | | | | | | | | | | | | |
| parts polyol | | | | | | | | | | | | |
| wt % Anhydride | | 0 | 0.10 | 0.20 | 0.40 | 1.00 | 0.80 | 0.40 | 1.2 | 0 | 0.4 | 0.20 |
| or acid | | | | | | | | | | | | |
| chloride/isocyanate | | | | | | | | | | | | |
| Molar fraction | | 0 | 0.18 | 0.35 | 0.71 | 1.78 | 1.42 | 0.26 | 0.78 | 0 | 0.62 | 0.17 |
| [mol %] based | | | | | | | | | | | | |
| on TDI | | | | | | | | | | | | |
| Remark | | Compar- | Compar- | | | Foam | Foam | | | Comparative | | |
| | | ative | ative | | | collapse | collapse | | | trial | | |
| | | trial | trial | | | | | | | | | |

*Analysis here could only be determined as the sum total of 2,4-TDA and 2,6-TDA.

Inventive trials 4 and 5 show distinctly lower FOG values than the comparative trial without maleic anhydride (comparison 1) or with very low amounts of acid anhydride (comparison 2). Equally, inventive trial 10 with citraconic anhydride shows distinctly lower FOG values in the VDA 278. Higher acid anhydride amounts than those claimed inventive results in unstable processing characteristics which manifests as foam collapse (comparison 5 and 6). If the molar fraction is taken into consideration, it can be processed analogously to dodecenylsuccinic anhydride (comparison 7 and 8). Comparative example 9 shows that high FOG values only arise at low indices. At an index of 105, the FOG value distinctly decreases, but the foam is also distinctly more rigid and is therefore no longer comparable with the foam at index 75.

Trial 11 shows the positive effect on the emissions using acid chlorides.

1. A method for producing a TDI-based flexible polyurethane foam, comprising reacting TDI with at least one hydroxyl group-containing compound in the presence of blowing agents and optionally auxiliaries and/or additives, at an isocyanate index of ≥70 to ≤85, wherein the reaction is carried out
in the presence of ≥0.20 to ≤1.25 mol % of at least one cyclic anhydride of a di- and/or polycarboxylic acid, based on the amount of TDI used, or
in the presence of ≥0.15 to ≤1.25 mol % of at least one carbonyl chloride, based on the amount of TDI used, and wherein the foam has a density of ≥20 kg m⁻³.

2. The method of claim 1, wherein ≥0.25 to ≤1.0 mol % of at least one cyclic anhydride of a di- or polycarboxylic acid is used.

3. The method of claim 1, wherein ≥0.25 to ≤1.0 mol % of at least one carbonyl chloride is used.

4. The method of claim 1, wherein the anhydrides used are cyclic anhydrides of a dicarboxylic acid.

5. The method of claim 1, wherein the at least one carbonyl chloride is selected from the group consisting of: aliphatic carbonyl chlorides having 2 to 22 carbon atoms, mixtures of C₈- to C₂₂-carbonyl chlorides, halogen substituted C₈- to C₂₂-carbonyl chlorides, nitro substituted C₈- to C₂₂-carbonyl chlorides, aromatic substituted carbonyl chlorides having 7 to 24 carbon atoms, cycloaliphatic substituted carbonyl chlorides having 7 to 24 carbon atoms, aralkyl-substituted carbonyl chlorides having 7 to 24 carbon atoms and alkylaryl-substituted carbonyl chlorides having 7 to 24 carbon atoms.

6. The method of claim 1, wherein the foam has a density of ≥30 kg m⁻³.

7. The method of claim 1, wherein the cyclic anhydrides are used in a mixture with the hydroxyl group-containing compound.

8. A flexible polyurethane foam produced by the method of claim 1.

9. The flexible polyurethane foam of claim 8, wherein the foam is molded foam.

10. A product comprising the flexible polyurethane foam of claim 8, wherein the product is selected from the group consisting of furniture cushioning, textile inlays, mattresses, automotive seats, headrests, armrests, sponges, headlinings, door trims, seat covers and constructional elements.

11. Flexible polyurethane foams comprising cyclic anhydrides of di- or polycarboxylic acids or carbonyl chlorides in amounts which are suitable for reducing the FOG value of the foams, determined in accordance with VDA 278, to a value≤250 mg/kg.

12. The flexible polyurethane foams of claim 11, wherein the cyclic anhydrides of di- or polycarboxylic acids or carbonyl chlorides are less than or equal to 225 mg/kg.
